(19) United States
(12) Patent Application Publication
(10) Pub. No.: US 2024/0284360 A1
(43) Pub. Date: Aug. 22, 2024

(54) RECEPTION OF OVERLAPPING COMMUNICATIONS

(71) Applicant: QUALCOMM Incorporated, San Diego, CA (US)

(72) Inventors: Mostafa KHOSHNEVISAN, San Diego, CA (US); Jae Ho RYU, San Diego, CA (US); Changhwan PARK, San Diego, CA (US)

(21) Appl. No.: 18/510,211

(22) Filed: Nov. 15, 2023

Related U.S. Application Data
(60) Provisional application No. 63/485,444, filed on Feb. 16, 2023.

(51) Int. Cl. H04W 56/00; H04W 72/1273; H04W 72/231; H04W 76/20

(52) U.S. Cl. CPC H04W 56/0015; H04W 72/1273; H04W 72/231; H04W 76/20

(57) ABSTRACT

Various aspects of the present disclosure generally relate to wireless communication. In some aspects, a user equipment (UE) may receive an indication that associates a first synchronization signal block (SSB) to a first SSB group and a second SSB to a second SSB group, the first SSB group and the second SSB group associated with a single physical cell identifier (PCI). The UE may receive one or more scheduling indications that schedule reception of the first SSB, on a first set of one or more time domain resources, and schedule reception of a downlink transmission, on a second set of one or more time domain resources that at least partially overlap with the first set of one or more time domain resources, via a beam associated with the second SSB of the second SSB group. Numerous other aspects are described.

### CROSS-REFERENCE TO RELATED APPLICATION

This patent application claims priority to U.S. Provisional Patent Application No. 63/485,444, filed on Feb. 16, 2023, entitled “RECEPTION OF OVERLAPPING COMMUNICATIONS,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for reception of overlapping communications.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving an indication that associates a first synchronization signal block (SSB) to a first SSB group and a second SSB to a second SSB group, the first SSB group and the second SSB group associated with a single physical cell identifier (PCI). The method may include receiving one or more scheduling indications that schedule reception of the first SSB, on a first set of one or more time domain resources, and schedule reception of a downlink transmission, on a second set of one or more time domain resources that at least partially overlap with the first set of one or more time domain resources, via a beam associated with the second SSB of the second SSB group.

Some aspects described herein relate to a method of wireless communication performed by a network node. The method may include transmitting an indication that associates a first SSB to a first SSB group and a second SSB to a second SSB group, the first SSB group and the second SSB group associated with a single PCI. The method may include transmitting, to a UE, one or more scheduling indications that schedule reception of the first SSB, on a first set of one or more time domain resources, and schedule reception of a downlink transmission, on a second set of one or more time domain resources that at least partially overlap with the first set of one or more time domain resources, via a beam associated with the second SSB of the second SSB group.

Some aspects described herein relate to a UE for wireless communication. The UE may include one or more memories and one or more processors coupled to the one or more memories. The one or more processors may be configured to receive an indication that associates a first SSB to a first SSB group and a second SSB to a second SSB group, the first SSB group and the second SSB group associated with a single PCI. The one or more processors may be configured to receive one or more scheduling indications that schedule reception of the first SSB, on a first set of one or more time domain resources, and schedule reception of a downlink transmission, on a second set of one or more time domain resources that at least partially overlap with the first set of one or more time domain resources, via a beam associated with the second SSB of the second SSB group.

Some aspects described herein relate to a network node for wireless communication. The network node may include one or more memories and one or more processors coupled to the one or more memories. The one or more processors may be configured to transmit an indication that associates a first SSB to a first SSB group and a second SSB to a second SSB group, the first SSB group and the second SSB group associated with a single PCI. The one or more processors may be configured to transmit, to a UE, one or more scheduling indications that schedule reception of the first SSB, on a first set of one or more time domain resources, and schedule reception of a downlink transmission, on a second set of one or more time domain resources that at least partially overlap with the first set of one or more time domain resources, via a beam associated with the second SSB of the second SSB group.

Some aspects described herein relate to a non-transitory computer-readable medium that stores a set of instructions for wireless communication by a UE. The set of instructions, when executed by one or more processors of the UE, may cause the UE to receive an indication that associates a first SSB to a first SSB group and a second SSB to a second SSB group, the first SSB group and the second SSB group associated with a single PCI. The set of instructions, when executed by one or more processors of the UE, may cause the UE to receive one or more scheduling indications that schedule reception of the first SSB, on a first set of one or more time domain resources, and schedule reception of a downlink transmission, on a second set of one or more time domain resources that at least partially overlap with the first set of one or more time domain resources, via a beam associated with the second SSB of the second SSB group.

Some aspects described herein relate to a non-transitory computer-readable medium that stores a set of instructions for wireless communication by a network node. The set of instructions, when executed by one or more processors of the network node, may cause the network node to transmit an indication that associates a first SSB to a first SSB group and a second SSB to a second SSB group, the first SSB group and the second SSB group associated with a single PCI. The set of instructions, when executed by one or more processors of the network node, may cause the network node to transmit, to a UE, one or more scheduling indications that schedule reception of the first SSB, on a first set of one or more time domain resources, and schedule reception of a downlink transmission, on a second set of one or more time domain resources that at least partially overlap with the first set of one or more time domain resources, via a beam associated with the second SSB of the second SSB group.

Some aspects described herein relate to an apparatus for wireless communication. The apparatus may include means for receiving an indication that associates a first SSB to a first SSB group and a second SSB to a second SSB group, the first SSB group and the second SSB group associated with a single PCI. The apparatus may include means for receiving one or more scheduling indications that schedule reception of the first SSB, on a first set of one or more time domain resources, and schedule reception of a downlink transmission, on a second set of one or more time domain resources that at least partially overlap with the first set of one or more time domain resources, via a beam associated with the second SSB of the second SSB group.

Some aspects described herein relate to an apparatus for wireless communication. The apparatus may include means for transmitting an indication that associates a first SSB to a first SSB group and a second SSB to a second SSB group, the first SSB group and the second SSB group associated with a single PCI. The apparatus may include means for transmitting, to a UE, one or more scheduling indications that schedule reception of the first SSB, on a first set of one or more time domain resources, and schedule reception of a downlink transmission, on a second set of one or more time domain resources that at least partially overlap with the first set of one or more time domain resources, via a beam associated with the second SSB of the second SSB group.

Aspects generally include a method, apparatus, system, computer program product, non-transitory computer-readable medium, user equipment, base station, network entity, network node, wireless communication device, and/or processing system as substantially described herein with reference to and as illustrated by the drawings, specification, and appendix.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 illustrates an example logical architecture of a distributed radio access network (RAN), in accordance with the present disclosure.

FIG. 5 is a diagram illustrating an example of multi-transmission reception point (TRP) communication (sometimes referred to as multi-panel communication), in accordance with the present disclosure.

FIG. 6 is a diagram illustrating an example of TRP differentiation at a UE based at least in part on a control resource set (CORESET) pool index, in accordance with the present disclosure.

FIG. 7 is a diagram illustrating an example of a synchronization signal (SS) hierarchy, in accordance with the present disclosure.

FIG. 8 is a diagram of an example associated with reception of overlapping communications, in accordance with the present disclosure.

FIG. 9 is a diagram illustrating an example process performed, for example, by a UE, in accordance with the present disclosure.

FIG. 10 is a diagram illustrating an example process performed, for example, by a network node, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

In some networks, a user equipment (UE) may be configured to receive a data communication on a first beam (e.g., associated with a first transmission configuration indicator (TCI) state) and a synchronization signal block (SSB) on a second beam (e.g., associated with a second TCI state) on overlapping time resources when the SSB is on an active TCI state and when the SSB is not configured for layer 1 (L1) reference signal received power (RSRP) measurement and a data communication is also scheduled for the second beam.

However, a UE that supports simultaneous reception on two beams (e.g., using two different antenna panels and/or antenna modules) may be capable of receiving a data communication via the first beam in overlapping resources with the SSB on the second beam, without being based on a presence of a data communication on the second beam and/or whether the SSB is associated with an active TCI state.

In some aspects described herein, a UE may indicate a capability to receive two beams simultaneously in the same component carrier (CC) and/or bandwidth part (BWP) (e.g., with two quasi-co-location (QCL)-TypeD properties at the same time). In this case, when two or more TCI states are activated for that BWP, and all active TCI states are associated with the same physical cell identifier (PCI) (e.g., for intra-cell multi-transmission reception point (mTRP)), the UE may receive an indication that groups actually transmitted SSBs into two groups. Each of the SSB groups may be associated with a respective transmission reception point (TRP), UE antenna panel, and/or beam group. The UE may receive a first SSB of a first SSB group and a downlink data communication or a reference signal with a TCI state that is associated with a second SSB of a second SSB group.

In this way, a network node may have increased flexibility to schedule communications for a UE using an mTRP scheme and/or using multiple TCI states. This flexibility may improve spectral efficiency and improve latency of communications that may otherwise be delayed based at least in part on waiting for a resource that does not overlap with an SSB.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

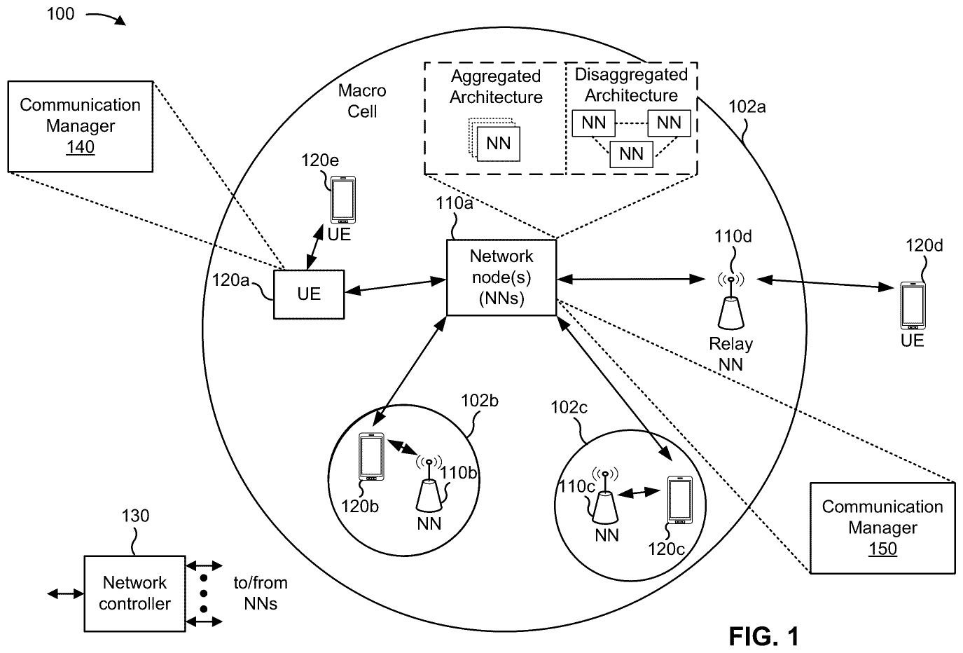

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a TRP, a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive an indication that associates a first SSB to a first SSB group and a second SSB to a second SSB group, the first SSB group and the second SSB group associated with a single PCI; and receive one or more scheduling indications that schedule reception of the first SSB, on a first set of one or more time domain resources, and schedule reception of a downlink transmission, on a second set of one or more time domain resources that at least partially overlap with the first set of one or more time domain resources, via a beam associated with the second SSB of the second SSB group. Additionally, or alternatively, the communication manager 140 may perform one or more other operations described herein.

In some aspects, the network node 110 may include a communication manager 150. As described in more detail elsewhere herein, the communication manager 150 may transmit an indication that associates a first SSB to a first SSB group and a second SSB to a second SSB group, the first SSB group and the second SSB group associated with a single PCI; and transmit, to a UE, one or more scheduling indications that schedule reception of the first SSB, on a first set of one or more time domain resources, and schedule reception of a downlink transmission, on a second set of one or more time domain resources that at least partially overlap with the first set of one or more time domain resources, via a beam associated with the second SSB of the second SSB group. Additionally, or alternatively, the communication manager 150 may perform one or more other operations described herein.

As indicated above, FIG. 1 is provided as an example. Other examples may differ from what is described with regard to FIG. 1.

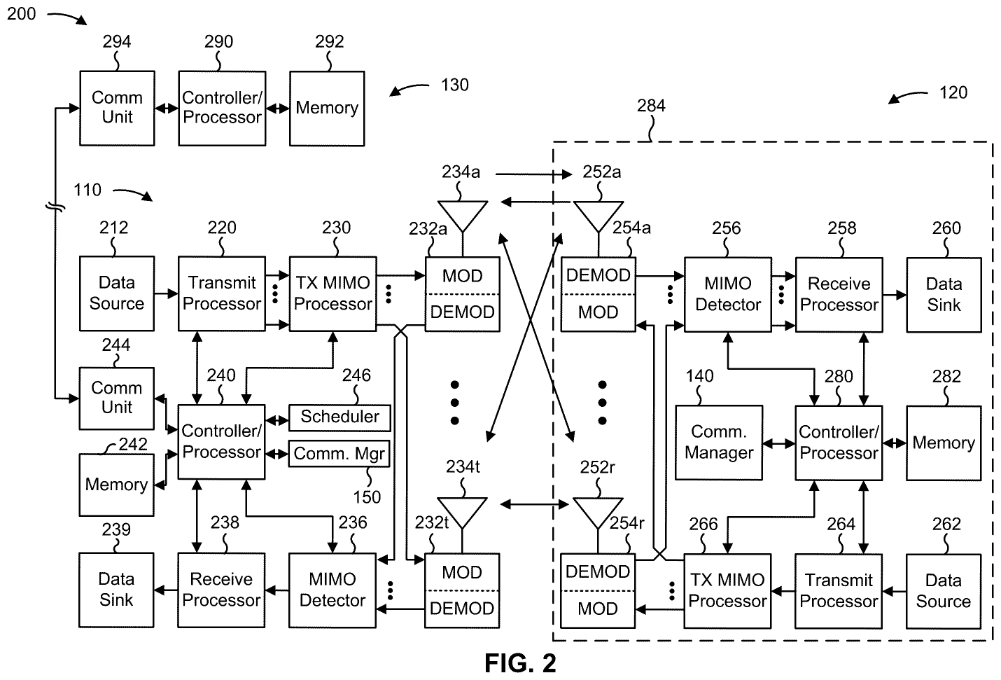

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a RSRP parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

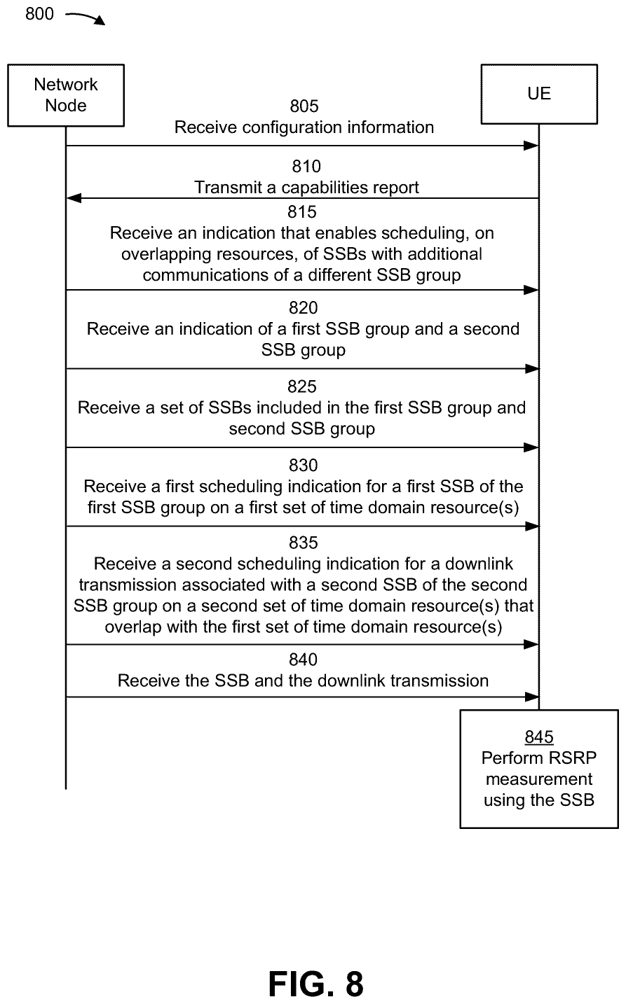

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 8-12).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 8-12).

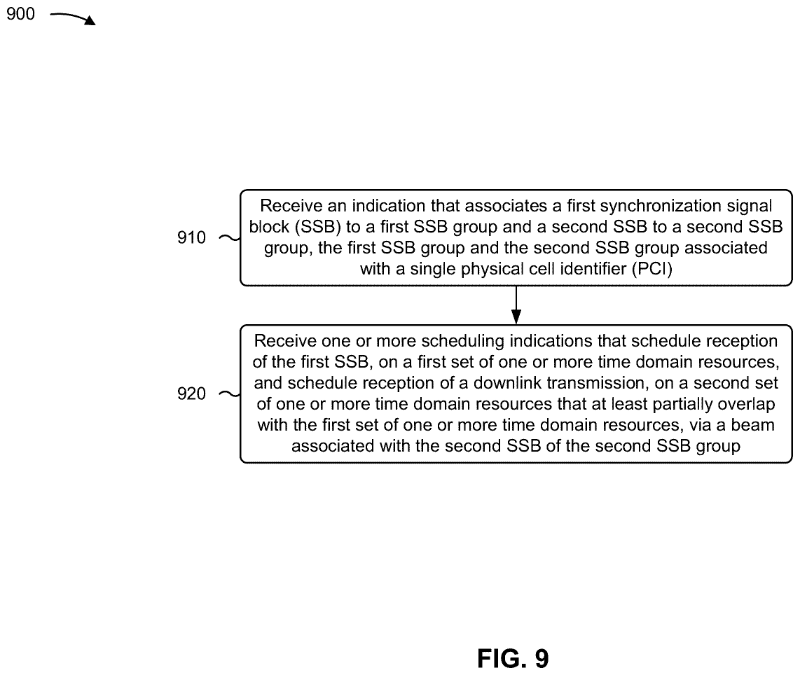

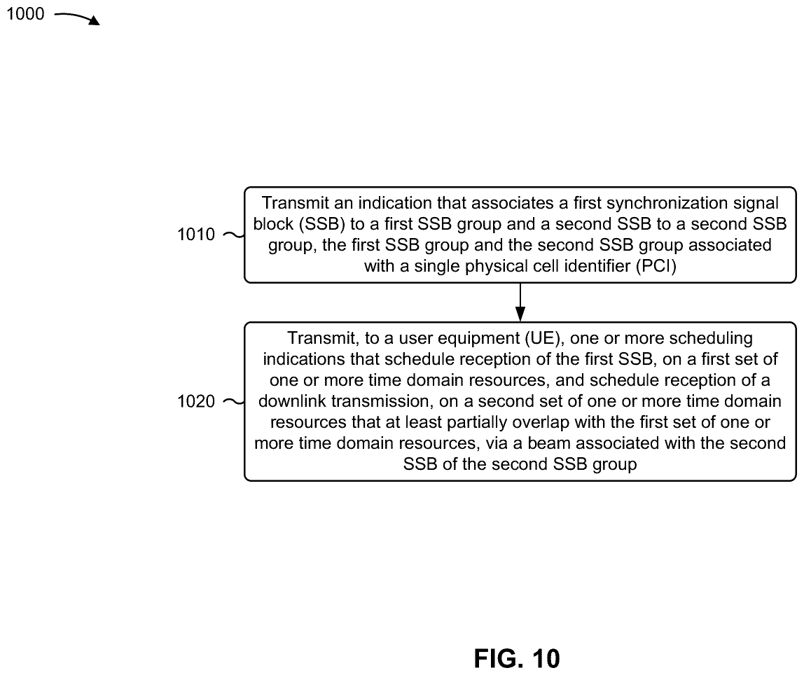

The controller/processor 240 of the network node 110, the controller/processor 280 of the UE 120, and/or any other component(s) of FIG. 2 may perform one or more techniques associated with reception of overlapping communications, as described in more detail elsewhere herein. For example, the controller/processor 240 of the network node 110, the controller/processor 280 of the UE 120, and/or any other component(s) of FIG. 2 may perform or direct operations of, for example, process 900 of FIG. 9, process 1000 of FIG. 10, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, the UE includes means for receiving an indication that associates a first SSB to a first SSB group and a second SSB to a second SSB group, the first SSB group and the second SSB group associated with a single PCI; and/or means for receiving one or more scheduling indications that schedule reception of the first SSB, on a first set of one or more time domain resources, and schedule reception of a downlink transmission, on a second set of one or more time domain resources that at least partially overlap with the first set of one or more time domain resources, via a beam associated with the second SSB of the second SSB group. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node includes means for transmitting an indication that associates a first SSB to a first SSB group and a second SSB to a second SSB group, the first SSB group and the second SSB group associated with a single PCI; and/or means for transmitting, to a UE, one or more scheduling indications that schedule reception of the first SSB, on a first set of one or more time domain resources, and schedule reception of a downlink transmission, on a second set of one or more time domain resources that at least partially overlap with the first set of one or more time domain resources, via a beam associated with the second SSB of the second SSB group. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

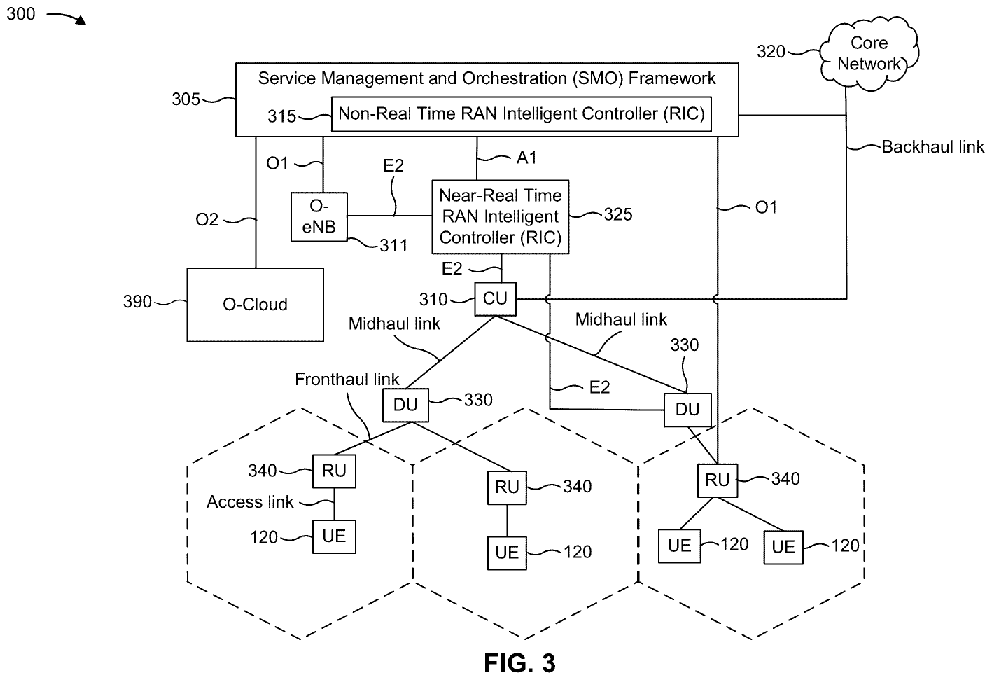

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit—User Plane (CU-UP) functionality), control plane functionality (for example, Central Unit—Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

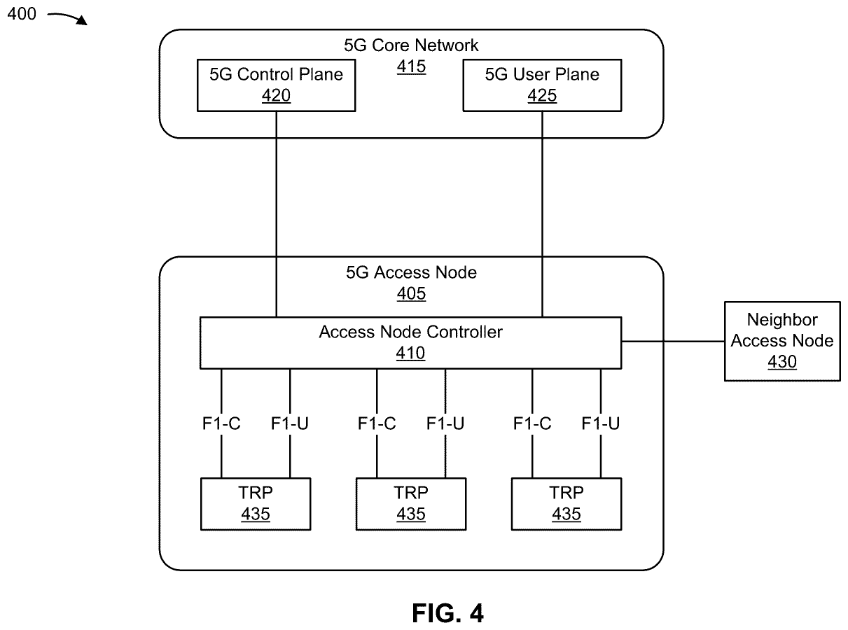

FIG. 4 illustrates an example logical architecture of a distributed RAN 400, in accordance with the present disclosure.

A 5G access node 405 may include an access node controller 410. The access node controller 410 may be a CU of the distributed RAN 400. In some aspects, a backhaul interface to a 5G core network 415 may terminate at the access node controller 410. The 5G core network 415 may include a 5G control plane component 420 and a 5G user plane component 425 (e.g., a 5G gateway), and the backhaul interface for one or both of the 5G control plane and the 5G user plane may terminate at the access node controller 410. Additionally, or alternatively, a backhaul interface to one or more neighbor access nodes 430 (e.g., another 5G access node 405 and/or an LTE access node) may terminate at the access node controller 410.

The access node controller 410 may include and/or may communicate with one or more TRPs 435 (e.g., via an F1 Control (F1-C) interface and/or an F1 User (F1-U) interface). A TRP 435 may include a DU and/or an RU of the distributed RAN 400. In some aspects, a TRP 435 may correspond to a network node 110 described above in connection with FIG. 1. For example, different TRPs 435 may be included in different network nodes 110. Additionally, or alternatively, multiple TRPs 435 may be included in a single network node 110. In some aspects, a network node 110 may include a CU (e.g., access node controller 410) and/or one or more DUs (e.g., one or more TRPs 435). In some cases, a TRP 435 may be referred to as a cell, a panel, an antenna array, or an array.

A TRP 435 may be connected to a single access node controller 410 or to multiple access node controllers 410. In some aspects, a dynamic configuration of split logical functions may be present within the architecture of distributed RAN 400, referred to elsewhere herein as a functional split. For example, a PDCP layer, an RLC layer, and/or a MAC layer may be configured to terminate at the access node controller 410 or at a TRP 435.

In some aspects, multiple TRPs 435 may transmit communications (e.g., the same communication or different communications) in the same transmission time interval (TTI) (e.g., a slot, a mini-slot, a subframe, or a symbol) or different TTIs using different QCL relationships (e.g., different spatial parameters, different TCI states, different precoding parameters, and/or different beamforming parameters). In some aspects, a TCI state may be used to indicate one or more QCL relationships. A TRP 435 may be configured to individually (e.g., using dynamic selection) or jointly (e.g., using joint transmission with one or more other TRPs 435) serve traffic to a UE 120.

As indicated above, FIG. 4 is provided as an example. Other examples may differ from what was described with regard to FIG. 4.

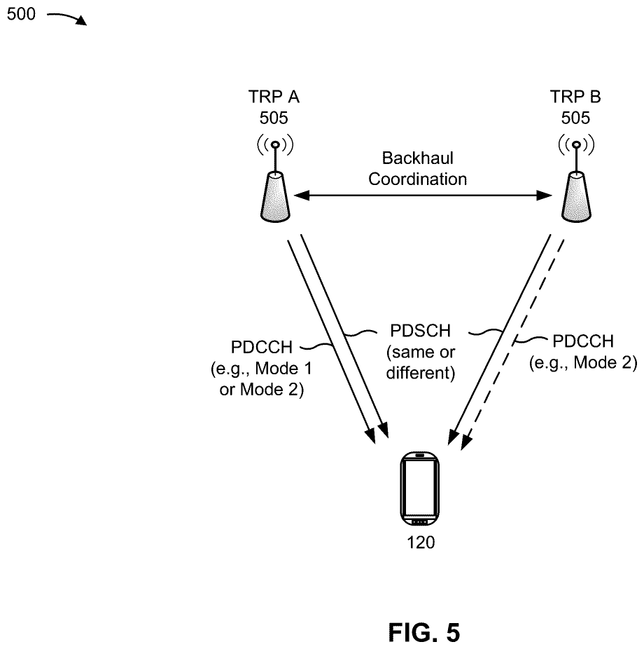

FIG. 5 is a diagram illustrating an example 500 of multi-TRP communication (sometimes referred to as multi-panel communication), in accordance with the present disclosure. As shown in FIG. 5, multiple TRPs 505 may communicate with the same UE 120. A TRP 505 may correspond to a TRP 435 described above in connection with FIG. 4.

The multiple TRPs 505 (shown as TRP A and TRP B) may communicate with the same UE 120 in a coordinated manner (e.g., using coordinated multipoint transmissions) to improve reliability and/or increase throughput. The TRPs 505 may coordinate such communications via an interface between the TRPs 505 (e.g., a backhaul interface and/or an access node controller 410). The interface may have a smaller delay and/or higher capacity when the TRPs 505 are co-located at the same network node 110 (e.g., when the TRPs 505 are different antenna arrays or panels of the same network node 110), and may have a larger delay and/or lower capacity (as compared to co-location) when the TRPs 505 are located at different network nodes 110. The different TRPs 505 may communicate with the UE 120 using different QCL relationships (e.g., different TCI states), different DMRS ports, and/or different layers (e.g., of a multi-layer communication).

In a first multi-TRP transmission mode (e.g., Mode 1), a single physical downlink control channel (PDCCH) may be used to schedule downlink data communications for a single physical downlink shared channel (PDSCH). In this case, multiple TRPs 505 (e.g., TRP A and TRP B) may transmit communications to the UE 120 on the same PDSCH. For example, a communication may be transmitted using a single codeword with different spatial layers for different TRPs 505 (e.g., where one codeword maps to a first set of layers transmitted by a first TRP 505 and maps to a second set of layers transmitted by a second TRP 505). As another example, a communication may be transmitted using multiple codewords, where different codewords are transmitted by different TRPs 505 (e.g., using different sets of layers). In either case, different TRPs 505 may use different QCL relationships (e.g., different TCI states) for different DMRS ports corresponding to different layers. For example, a first TRP 505 may use a first QCL relationship or a first TCI state for a first set of DMRS ports corresponding to a first set of layers, and a second TRP 505 may use a second (different) QCL relationship or a second (different) TCI state for a second (different) set of DMRS ports corresponding to a second (different) set of layers. Alternatively, the two TCI states may correspond to different sets of RBs (e.g., in a frequency division multiplexing (FDM) scheme), different sets of symbols or slots (time division multiplexing (TDM) scheme). Additionally, each DMRS port of the PDSCH may be associated with both TCI states in all symbols and RBs (single frequency network (SFN) scheme). In some aspects, a TCI state in downlink control information (DCI) (e.g., transmitted on the PDCCH, such as DCI format 1_0 or DCI format 1_1 or DCI format 1_2) may indicate the first QCL relationship (e.g., by indicating a first TCI state) and the second QCL relationship (e.g., by indicating a second TCI state). The first and the second TCI states may be indicated using a TCI field in the DCI. In general, the TCI field can indicate a single TCI state (for single-TRP transmission) or multiple TCI states (for multi-TRP transmission as discussed here) in this multi-TRP transmission mode (e.g., Mode 1).

In a second multi-TRP transmission mode (e.g., Mode 2), multiple PDCCHs may be used to schedule downlink data communications for multiple corresponding PDSCHs (e.g., one PDCCH for each PDSCH). In this case, a first PDCCH may schedule a first codeword to be transmitted by a first TRP 505, and a second PDCCH may schedule a second codeword to be transmitted by a second TRP 505. Furthermore, first DCI (e.g., transmitted by the first TRP 505) may schedule a first PDSCH communication associated with a first set of DMRS ports with a first QCL relationship (e.g., indicated by a first TCI state) for the first TRP 505, and second DCI (e.g., transmitted by the second TRP 505) may schedule a second PDSCH communication associated with a second set of DMRS ports with a second QCL relationship (e.g., indicated by a second TCI state) for the second TRP 505. In this case, DCI (e.g., having DCI format 1_0 or DCI format 1_1 or DCI format 1_2) may indicate a corresponding TCI state for a TRP 505 corresponding to the DCI. The TCI field of a DCI indicates the corresponding TCI state (e.g., the TCI field of the first DCI indicates the first TCI state and the TCI field of the second DCI indicates the second TCI state).

As indicated above, FIG. 5 is provided as an example. Other examples may differ from what is described with respect to FIG. 5.

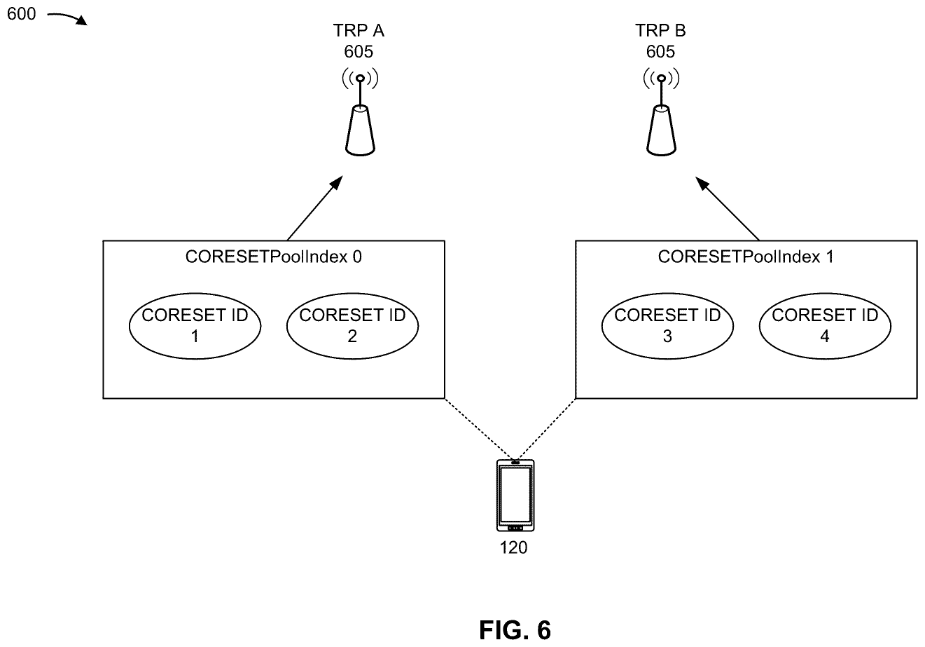

FIG. 6 is a diagram illustrating an example 600 of TRP differentiation at a UE based at least in part on a control resource set (CORESET) pool index, in accordance with the present disclosure. In some aspects, a CORESET pool index (or CORESETPoolIndex) value may be used by a UE (a UE 120) to identify a TRP associated with an uplink grant received on a PDCCH.

A CORESET may refer to a control region that is structured to support an efficient use of resources, such as by flexible configuration or reconfiguration of resources for one or more PDCCHs associated with a UE. In some aspects, a CORESET may occupy the first symbol of an orthogonal frequency division multiplexing (OFDM) slot, the first two symbols of an OFDM slot, or the first three symbols of an OFDM slot. Thus, a CORESET may include multiple resource blocks (RBs) in the frequency domain, and either one, two, or three symbols in the time domain. In 5G, a quantity of resources included in a CORESET may be flexibly configured, such as by using RRC signaling to indicate a frequency domain region (for example, a quantity of resource blocks) or a time domain region (for example, a quantity of symbols) for the CORESET.

As illustrated in FIG. 6, a UE 120 may be configured with multiple CORESETs in a given serving cell. Each CORESET configured for the UE 120 may be associated with a CORESET identifier (CORESET ID). For example, a first CORESET configured for the UE 120 may be associated with CORESET ID 1, a second CORESET configured for the UE 120 may be associated with CORESET ID 2, a third CORESET configured for the UE 120 may be associated with CORESET ID 3, and a fourth CORESET configured for the UE 120 may be associated with CORESET ID 4.

As further illustrated in FIG. 6, two or more (for example, up to five) CORESETs may be grouped into a CORESET pool. Each CORESET pool may be associated with a CORESET pool index. As an example, CORESET ID 1 and CORESET ID 2 may be grouped into CORESET pool index 0, and CORESET ID 3 and CORESET ID 4 may be grouped into CORESET pool index 1. In a multi-TRP configuration, each CORESET pool index value may be associated with a particular TRP 605. As an example, and as illustrated in FIG. 6, a first TRP 605 (TRP A) (or a first network node 110) may be associated with CORESET pool index 0 and a second TRP 605 (TRP B) (or a second network node 110) may be associated with CORESET pool index 1. The UE 120 may be configured by a higher layer parameter, such as PDCCH-Config, with information identifying an association between a TRP and a CORESET pool index value assigned to the TRP. Accordingly, the UE may identify the TRP that transmitted a DCI downlink or uplink grant by determining the CORESET ID of the CORESET in which the PDCCH carrying the DCI downlink or uplink grant was transmitted, determining the CORESET pool index value associated with the CORESET pool in which the CORESET ID is included, and identifying the TRP associated with the CORESET pool index value.

In some examples herein, reference may be made to a TRP. However, the TRPs may be transparent to the UE and/or may be known to the UE based at least in part on an associated of a CORESETPoolIndex with a TRP.

As indicated above, FIG. 6 is provided as an example. Other examples may differ from what is described with respect to FIG. 6.

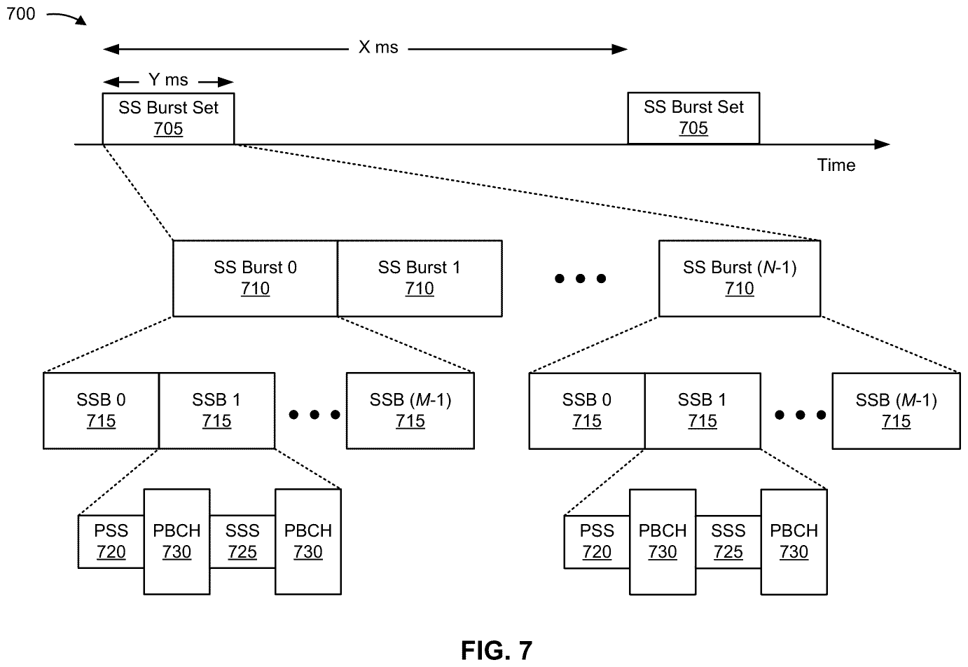

FIG. 7 is a diagram illustrating an example 700 of a synchronization signal (SS) hierarchy, in accordance with the present disclosure. As shown in FIG. 7, the SS hierarchy may include an SS burst set 705, which may include multiple SS bursts 710, shown as SS burst 0 through SS burst N−1, where N is a maximum number of repetitions of the SS burst 710 that may be transmitted by one or more network nodes. As further shown, each SS burst 710 may include one or more SSBs 715, shown as SSB 0 through SSB M−1, where M is a maximum number of SSBs 715 that can be carried by an SS burst 710. In some aspects, different SSBs 715 may be beam-formed differently (e.g., transmitted using different beams), and may be used for cell search, cell acquisition, beam management, and/or beam selection (e.g., as part of an initial network access procedure). An SS burst set 705 may be periodically transmitted by a wireless node (e.g., a network node 110), such as every X milliseconds, as shown in FIG. 7. In some aspects, an SS burst set 705 may have a fixed or dynamic length, shown as Y milliseconds in FIG. 7. In some cases, an SS burst set 705 or an SS burst 710 may be referred to as a discovery reference signal (DRS) transmission window or an SSB measurement time configuration (SMTC) window.

In some aspects, an SSB 715 may include resources that carry a PSS 720, an SSS 725, and/or a physical broadcast channel (PBCH) 730. In some aspects, multiple SSBs 715 are included in an SS burst 710 (e.g., with transmission on different beams), and the PSS 720, the SSS 725, and/or the PBCH 730 may be the same across each SSB 715 of the SS burst 710. In some aspects, a single SSB 715 may be included in an SS burst 710. In some aspects, the SSB 715 may be at least four symbols (e.g., OFDM symbols) in length, where each symbol carries one or more of the PSS 720 (e.g., occupying one symbol), the SSS 725 (e.g., occupying one symbol), and/or the PBCH 730 (e.g., occupying two symbols). In some aspects, an SSB 715 may be referred to as an SS/PBCH block.

In some aspects, the symbols of an SSB 715 are consecutive, as shown in FIG. 7. In some aspects, the symbols of an SSB 715 are non-consecutive. Similarly, in some aspects, one or more SSBs 715 of the SS burst 710 may be transmitted in consecutive radio resources (e.g., consecutive symbols) during one or more slots. Additionally, or alternatively, one or more SSBs 715 of the SS burst 710 may be transmitted in non-consecutive radio resources.

In some aspects, the SS bursts 710 may have a burst period, and the SSBs 715 of the SS burst 710 may be transmitted by a wireless node (e.g., a network node 110) according to the burst period. In this case, the SSBs 715 may be repeated during each SS burst 710. In some aspects, the SS burst set 705 may have a burst set periodicity, whereby the SS bursts 710 of the SS burst set 705 are transmitted by the wireless node according to the fixed burst set periodicity. In other words, the SS bursts 710 may be repeated during each SS burst set 705.

In some aspects, an SSB 715 may include an SSB index, which may correspond to a beam used to carry the SSB 715. A UE 120 may monitor for and/or measure SSBs 715 using different receive (Rx) beams during an initial network access procedure and/or a cell search procedure, among other examples. Based at least in part on the monitoring and/or measuring, the UE 120 may indicate one or more SSBs 715 with a best signal parameter (e.g., a RSRP parameter) to a network node 110 (e.g., directly or via one or more other network nodes). The network node 110 and the UE 120 may use the one or more indicated SSBs 715 to select one or more beams to be used for communication between the network node 110 and the UE 120 (e.g., for a random access channel (RACH) procedure). Additionally, or alternatively, the UE 120 may use the SSB 715 and/or the SSB index to determine a cell timing for a cell via which the SSB 715 is received (e.g., a serving cell).

As indicated above, FIG. 7 is provided as an example. Other examples may differ from what is described with regard to FIG. 7.

In some networks, a UE may be configured to receive a data communication on a first beam (e.g., associated with a first TCI state) and a SSB on a second beam (e.g., associated with a second TCI state) on overlapping time resources when the SSB is associated with an active TCI state and when the SSB is not configured for L1 RSRP measurement and a data communication is also scheduled for the second beam.

However, a UE that supports simultaneous reception on two beams (e.g., using two different antenna panels and/or antenna modules) may be capable of receiving a data communication via the first beam in overlapping resources with the SSB on the second beam, without being based on a presence of a data communication on the second beam and/or irrespective of whether the SSB is associated with an active TCI state.

In some aspects described herein, a UE may indicate a capability to receive two beams simultaneously in the same CC and/or BWP (e.g., with two QCL-TypeD properties at the same time). In this case, when two or more TCI states are activated for that BWP, and all active TCI states are associated with the same PCI (e.g., for intra-cell mTRP), the UE may receive an indication of SSB positions within an SSB burst (e.g., ssb-PositionsInBurst), and the UE may receive an indication that groups actually transmitted SSBs into two groups. The UE may receive the indication via an RRC message (e.g., in a system information block (SIB) or dedicated RRC), a MAC control element (CE), or DCI, among other examples.

Each of the SSB groups may be associated with a respective TRP, UE antenna panel, and/or beam group. In case of multi-DCI mTRP, each group may be associated with a CORESETPoolIndex. In this case, the TCI states are already activated per CORESETPoolIndex (e.g., at least one active TCI state is associated with CORESETPoolIndex value 0, and at least another active TCI state is associated with CORESETPoolIndex value 1). In case of single-DCI, each group is associated with a group of active TCI states. If only two TCI states are activated, then each SSB group corresponds to one active TCI state. For example, a first active TCI state is associated with an SSB index in the first SSB group, and a second active TCI state is associated with a SSB index in the second SSB group.

The UE may receive a first SSB of a first SSB group and a downlink communication (e.g., PDSCH or PDCCH) or a reference signal (e.g., tracking reference signal (TRS) or channel state information reference signals (CSI-RSs) for a channel quality indication measurement, among other examples) with a TCI state that is associated with a second SSB of a second SSB group. The scheduling may be independent from a presence of an additional downlink communication and/or reference signal associated with the first SSB group.

In some aspects, the UE may receive the first SSB of the first SSB group and the downlink communication or the reference signal with a TCI state that is associated with a second SSB of a second SSB group based at least in part on one or more conditions. For example, this may be permitted if the TCI state associated with the second SSB is among two or more active TCI states. In another example, this may be permitted only if the first SSB in the first SSB group is associated with an active TCI state. In some examples, this may be permitted irrespective of whether the first SSB in the first SSB group is associated with an active TCI state. In some aspects, this may be permitted only if the first SSB is not configured for L1-RSRP measurements. Alternatively, this may be permitted irrespective of whether the first SSB is configured for L1-RSRP measurements. In some aspects, one or more of the conditions may be selected based at least in part on a capability of the UE, a configuration from the network node, and/or a communication protocol, among other examples.

In this way, a network node may have increased flexibility to schedule communications for a UE using an mTRP scheme and/or using multiple TCI states. This flexibility may improve spectral efficiency and improve latency of communications that may otherwise be delayed based at least in part on waiting for a resource that does not overlap with an SSB.

FIG. 8 is a diagram of an example 800 associated with reception of overlapping communications, in accordance with the present disclosure. As shown in FIG. 8, a network node (e.g., network node 110, a CU, a DU, and/or an RU) may communicate with a UE (e.g., UE 120). In some aspects, the network node and the UE may be part of a wireless network (e.g., wireless network 100). The UE and the network node may have established a wireless connection prior to operations shown in FIG. 8.

As shown by reference number 805, the network node may transmit, and the UE may receive, configuration information. In some aspects, the UE may receive the configuration information via one or more of RRC signaling, one or more MAC CEs, and/or DCI, among other examples. In some aspects, the configuration information may include an indication of one or more configuration parameters (e.g., already known to the UE and/or previously indicated by the network node or other network device) for selection by the UE, and/or explicit configuration information for the UE to use to configure the UE, among other examples.

In some aspects, the configuration information may indicate that the UE is to transmit a capability to receive an SSB on a first beam and a communication on a second beam. For example, the UE may indicate one or more conditions for supporting reception of the SSB on the first beam and the communication on the second beam.

The UE may configure itself based at least in part on the configuration information. In some aspects, the UE may be configured to perform one or more operations described herein based at least in part on the configuration information.

As shown by reference number 810, the UE may transmit, and the network node may receive, a capabilities report. In some aspects, the capabilities report may indicate UE support for receiving an SSB on a first beam and a communication (e.g., data, control information, or a reference signal) on a second beam. For example, the UE may indicate one or more conditions for supporting reception of the communication on the second beam and the SSB on the first beam. For example, the UE may support reception of the first SSB and the downlink transmission on overlapping resources based at least in part on the first SSB not being configured for RSRP measurement. In some aspects, the UE may support reception of the first SSB and the downlink transmission on overlapping resources whether or not the first SSB is configured for RSRP measurement.

The indication may further be used to indicate support for receiving communications via multiple beams in overlapping time resources via a single component carrier or bandwidth part.

As shown by reference number 815, the UE may receive, and the network node may transmit, an indication that enables scheduling, on overlapping resources, of SSBs with additional communications of a different SSB group. For example, the network node may transmit the indication based at least in part on receiving the capabilities report from the UE that indicates UE support for scheduling of SSBs with additional communications of a different SSB group on overlapping resources.

As shown by reference number 820, the UE may receive, and the network node may transmit, an indication of a first SSB group and a second SSB group. For example, the network node may indicate members of the first SSB group and members of the second SSB group based at least in part on positions of SSBs within one or more SSB bursts. For example, a first quantity of SSBs may be associated with a first SSB group (e.g., that is in turn associated with a first CORESETPoolIndex and/or a first TRP, among other examples) based at least in part on locations of the first quantity of SSBs within the one or more SSB bursts, and a second quantity of SSBs may be associated with a second SSB group (e.g., that is in turn associated with a second CORESETPoolIndex and/or a second TRP, among other examples) based at least in part on locations of the second quantity of SSBs within the one or more SSB bursts.

In some aspects, the first SSB group and the second SSB group are associated with a single PCI. This may be based at least in part on the SSBs being associated with the network node (e.g., one or more TRPs associated with the network node).

In some aspects, the network node may transmit, and the UE may receive, the indication of the first SSB group and the second SSB group as an indication that associates a first SSB to a first SSB group and a second SSB to a second SSB group. The UE may receive the indication via a SIB, a unicast RRC communication, a MAC CE, and/or DCI.

In some aspects, the network node may provide an indication of SSB positions within an SSB burst (e.g., ssb-PositionsInBurst), which may indicate actually transmitted SSBs.

As shown by reference number 825, the UE may receive, and the network node may transmit, a set of SSBs included in the first SSB group and the second SSB group. The UE may measure the SSBs for an L1-RSRP measurement and reporting. In some aspects, the set of SSBs (e.g., actually transmitted SSBs) may include a first SSB (described in connection with reference number 830) and a second SSB (described in connection with reference number 835).

As shown by reference number 830, the UE may receive, and the network node may transmit, a first scheduling indication for a first SSB of the first SSB group on a first set of one or more time domain resources. In some aspects, the first SSB group may be associated with one or more of a first TRP, a first panel of the UE, and/or a first beam group. In some aspects, the first SSB group and the second SSB group may be associated with a group of active TCI states.

In some aspects, the first SSB may be configured for RSRP measurement. In some aspects, the first SSB may not be configured for RSRP measurement.

As shown by reference number 835, the UE may receive, and the network node may transmit, a second scheduling indication for a downlink transmission associated with a second SSB of the second SSB group on a second set of one or more time domain resources that overlap with the first set of time domain resources. In some aspects, the second SSB group may be associated with one or more of a second TRP that is different from the first TRP, a second panel of the UE that is different from the first panel of the UE, and/or a second beam group that is different from the first beam group, among other examples.

In some aspects, the downlink transmission may include a downlink control communication, a downlink data communication, and/or a reference signal, among other examples.

In some aspects, the first SSB group and the second SSB group may be associated with a group of active TCI states. For example, a first active TCI state (e.g., active for downlink transmission to the UE) may be associated with an SSB index of the first SSB group and a second active TCI state may be associated with an SSB index of the second SSB group.

In some aspects, the UE may receive the first scheduling indication and the second scheduling indication via a single DCI message (e.g., a single-DCI mTRP configuration) or via multiple DCI messages (e.g., a multi-DCI mTRP configuration).

As shown by reference number 840, the UE may receive, and the network node may transmit, the SSB and the downlink transmission. In some aspects, the first set of time domain resources partially overlap or fully overlap (e.g., a same set of time domain resources) with the second set of time domain resources. In some aspects, the first SSB and the downlink transmission are frequency-division multiplexed (e.g., transmitted via different frequency domain resources).

As shown by reference number 845, the UE may perform RSRP measurement using the SSB. The UE may receive the downlink transmission in addition to performing RSRP measurement (e.g., performing RSRP measurement using the SSB may not prohibit receiving the downlink transmission).

Based at least in part on the network node having increased flexibility to schedule communications for a UE using an mTRP scheme and/or using multiple TCI states, the network node may improve spectral efficiency and improve latency of communications that may otherwise be delayed based at least in part on waiting for a resource that does not overlap with an SSB.

As indicated above, FIG. 8 is provided as an example. Other examples may differ from what is described with respect to FIG. 8.

FIG. 9 is a diagram illustrating an example process 900 performed, for example, by a UE, in accordance with the present disclosure. Example process 900 is an example where the UE (e.g., UE 120) performs operations associated with reception of overlapping communications.

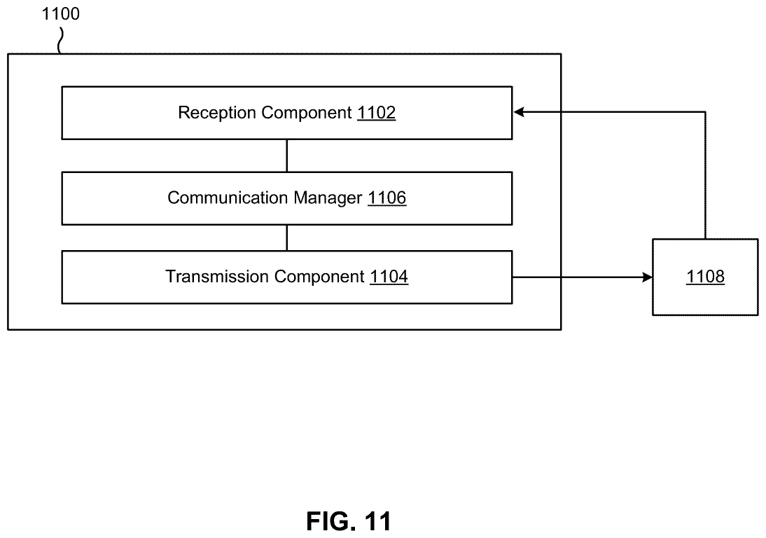

As shown in FIG. 9, in some aspects, process 900 may include receiving an indication that associates a first SSB to a first SSB group and a second SSB to a second SSB group, the first SSB group and the second SSB group associated with a single PCI (block 910). For example, the UE (e.g., using reception component 1102 and/or communication manager 1106, depicted in FIG. 11) may receive an indication that associates a first SSB to a first SSB group and a second SSB to a second SSB group, the first SSB group and the second SSB group associated with a single PCI, as described above.

As further shown in FIG. 9, in some aspects, process 900 may include receiving one or more scheduling indications that schedule reception of the first SSB, on a first set of one or more time domain resources, and schedule reception of a downlink transmission, on a second set of one or more time domain resources that at least partially overlap with the first set of one or more time domain resources, via a beam associated with the second SSB of the second SSB group (block 920). For example, the UE (e.g., using reception component 1102 and/or communication manager 1106, depicted in FIG. 11) may receive one or more scheduling indications that schedule reception of the first SSB, on a first set of one or more time domain resources, and schedule reception of a downlink transmission, on a second set of one or more time domain resources that at least partially overlap with the first set of one or more time domain resources, via a beam associated with the second SSB of the second SSB group, as described above.

Process 900 may include additional aspects, such as any single aspect or any combination of aspects described below and/or in connection with one or more other processes described elsewhere herein.

In a first aspect, process 900 includes transmitting an indication of support for receiving communications via multiple beams in overlapping time resources via a single component carrier or bandwidth part.

In a second aspect, alone or in combination with the first aspect, the indication of support for receiving communications via multiple beams in overlapping time resources comprises an indication of support for receiving a first communication that includes an SSB and a second communication that includes data, control information, or a reference signal.

In a third aspect, alone or in combination with one or more of the first and second aspects, the first SSB group is associated with one or more of a first TRP, a first panel of the UE, or a first beam group, and the second SSB group is associated with one or more of a second TRP that is different from the first TRP, a second panel of the UE that is different from the first panel of the UE, or a second beam group that is different from the first beam group.

In a fourth aspect, alone or in combination with one or more of the first through third aspects, the first SSB group is associated with a first control resource set pool index, and the second SSB group is associated with a second control resource set pool index.

In a fifth aspect, alone or in combination with one or more of the first through fourth aspects, the first SSB group and the second SSB group are associated with a group of active TCI states.

In a sixth aspect, alone or in combination with one or more of the first through fifth aspects, a first active TCI state is associated with an SSB index of the first SSB group, and a second active TCI state is associated with an SSB index of the second SSB group.

In a seventh aspect, alone or in combination with one or more of the first through sixth aspects, receiving the indication that associates the first SSB to the first SSB group and the second SSB to the second SSB group comprises receiving the indication that associates the first SSB to the first SSB group and the second SSB to the second SSB group via one or more of a SIB, a unicast RRC communication, a MAC CE, or DCI.

In an eighth aspect, alone or in combination with one or more of the first through seventh aspects, a set of transmitted SSBs includes SSBs of the first SSB group and SSBs of the second SSB group.

In a ninth aspect, alone or in combination with one or more of the first through eighth aspects, the downlink transmission comprises one or more of a downlink control communication, a downlink data communication, or a reference signal.

In a tenth aspect, alone or in combination with one or more of the first through ninth aspects, the UE supports reception of the first SSB and the downlink transmission on overlapping resources based at least in part on one or more of the second SSB being associated with an active TCI state, the first SSB being associated with a first active TCI state and the second SSB being associated with a second active TCI state, or the first SSB not being associated with an active TCI state.

In an eleventh aspect, alone or in combination with one or more of the first through tenth aspects, the UE supports reception of the first SSB and the downlink transmission on overlapping resources based at least in part on the first SSB not being configured for RSRP measurement.

In a twelfth aspect, alone or in combination with one or more of the first through eleventh aspects, the first SSB is configured for RSRP measurement.

In a thirteenth aspect, alone or in combination with one or more of the first through twelfth aspects, process 900 includes receiving an indication that enables scheduling, using at least partially overlapping resources, of SSBs with additional communications that are associated with an SSB group that does not include the SSBs.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a network node, in accordance with the present disclosure. Example process 1000 is an example where the network node (e.g., network node 110) performs operations associated with reception of overlapping communications.

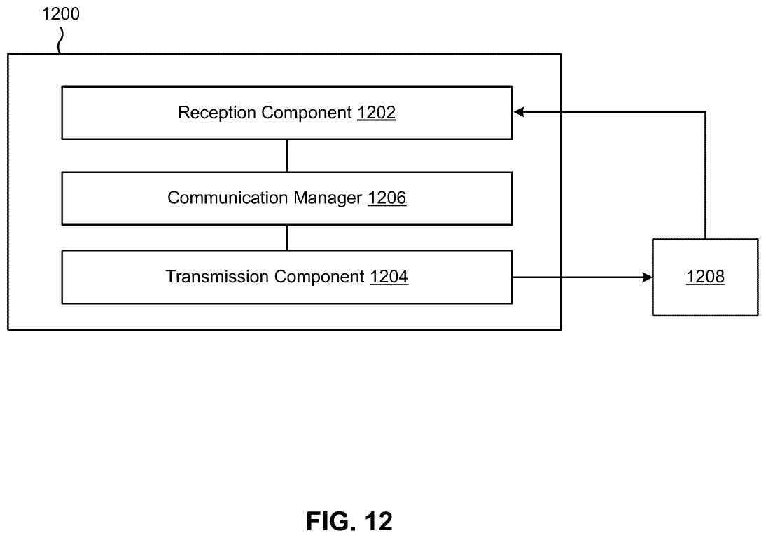

As shown in FIG. 10, in some aspects, process 1000 may include transmitting an indication that associates a first SSB to a first SSB group and a second SSB to a second SSB group, the first SSB group and the second SSB group associated with a single PCI (block 1010). For example, the network node (e.g., using transmission component 1204 and/or communication manager 1206, depicted in FIG. 12) may transmit an indication that associates a first SSB to a first SSB group and a second SSB to a second SSB group, the first SSB group and the second SSB group associated with a single PCI, as described above.

As further shown in FIG. 10, in some aspects, process 1000 may include transmitting, to a UE, one or more scheduling indications that schedule reception of the first SSB, on a first set of one or more time domain resources, and schedule reception of a downlink transmission, on a second set of one or more time domain resources that at least partially overlap with the first set of one or more time domain resources, via a beam associated with the second SSB of the second SSB group (block 1020). For example, the network node (e.g., using transmission component 204 and/or communication manager 1206, depicted in FIG. 12) may transmit, to a UE, one or more scheduling indications that schedule reception of the first SSB, on a first set of one or more time domain resources, and schedule reception of a downlink transmission, on a second set of one or more time domain resources that at least partially overlap with the first set of one or more time domain resources, via a beam associated with the second SSB of the second SSB group, as described above.

Process 1000 may include additional aspects, such as any single aspect or any combination of aspects described below and/or in connection with one or more other processes described elsewhere herein.

In a first aspect, process 1000 includes receiving, from the UE, an indication of support for receiving communications via multiple beams in overlapping time resources via a single component carrier or bandwidth part.

In a second aspect, alone or in combination with the first aspect, the indication of support for receiving communications via multiple beams in overlapping time resources comprises an indication of support for receiving a first communication that includes an SSB and a second communication that includes data, control information, or a reference signal.

In a third aspect, alone or in combination with one or more of the first and second aspects, the first SSB group is associated with one or more of a first TRP associated with the network node, a first panel of the UE, or a first beam group, and the second SSB group is associated with one or more of a second TRP that is different from the first TRP and is associated with the network node, a second panel of the UE that is different from the first panel of the UE, or a second beam group that is different from the first beam group.

In a fourth aspect, alone or in combination with one or more of the first through third aspects, the first SSB group is associated with a first control resource set pool index, and the second SSB group is associated with a second control resource set pool index.

In a fifth aspect, alone or in combination with one or more of the first through fourth aspects, the first SSB group and the second SSB group are associated with a group of active TCI states.

In a sixth aspect, alone or in combination with one or more of the first through fifth aspects, a first active TCI state is associated with an SSB index of the first SSB group, and a second active TCI state is associated with an SSB index of the second SSB group.

In a seventh aspect, alone or in combination with one or more of the first through sixth aspects, transmitting the indication that associates the first SSB to the first SSB group and the second SSB to the second SSB group comprises transmitting the indication that associates the first SSB to the first SSB group and the second SSB to the second SSB group via one or more of a SIB, a RRC communication, a MAC CE, or downlinking control information (DCI).

In an eighth aspect, alone or in combination with one or more of the first through seventh aspects, a set of transmitted SSBs includes SSBs of the first SSB group and SSBs of the second SSB group.

In a ninth aspect, alone or in combination with one or more of the first through eighth aspects, the downlink transmission comprises one or more of a downlink control communication, a downlink data communication, or a reference signal.

In a tenth aspect, alone or in combination with one or more of the first through ninth aspects, the UE supports reception of the first SSB and the downlink transmission on overlapping resources based at least in part on one or more of the second SSB being associated with an active TCI state, the first SSB being associated with a first active TCI state and the second SSB being associated with a second active TCI state, or the first SSB not being associated with an active TCI state.

In an eleventh aspect, alone or in combination with one or more of the first through tenth aspects, the UE supports reception of the first SSB and the downlink transmission on overlapping resources based at least in part on the first SSB not being configured for RSRP measurement.

In a twelfth aspect, alone or in combination with one or more of the first through eleventh aspects, the first SSB is configured for RSRP measurement.

In a thirteenth aspect, alone or in combination with one or more of the first through twelfth aspects, process 1000 includes transmitting an indication that enables scheduling, using at least partially overlapping resources, of SSBs with additional communications that are associated with an SSB group that does not include the SSBs.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 140 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIG. 8. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, a modem, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive an indication that associates a first SSB to a first SSB group and a second SSB to a second SSB group, the first SSB group and the second SSB group associated with a single PCI. The reception component 1102 may receive one or more scheduling indications that schedule reception of the first SSB, on a first set of one or more time domain resources, and schedule reception of a downlink transmission, on a second set of one or more time domain resources that at least partially overlap with the first set of one or more time domain resources, via a beam associated with the second SSB of the second SSB group.

The transmission component 1104 may transmit an indication of support for receiving communications via multiple beams in overlapping time resources via a single component carrier or bandwidth part.

The reception component 1102 may receive an indication that enables scheduling, using at least partially overlapping resources, of SSBs with additional communications that are associated with an SSB group that does not include the SSBs.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 150 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIG. 8. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the network node described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the network node described in connection with FIG. 2. In some aspects, the reception component 1202 and/or the transmission component 1204 may include or may be included in a network interface. The network interface may be configured to obtain and/or output signals for the apparatus 1200 via one or more communications links, such as a backhaul link, a midhaul link, and/or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, a modem, a modulator, a transmit MIMO processor, a transmit processor, a controller/processor, a memory, or a combination thereof, of the network node described in connection with FIG. 2. In some aspects, the transmission component 1204 may be co-located with the reception component 1202 in a transceiver.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The transmission component 1204 may transmit an indication that associates a first SSB to a first SSB group and a second SSB to a second SSB group, the first SSB group and the second SSB group associated with a single PCI. The transmission component 1204 may transmit, to a UE, one or more scheduling indications that schedule reception of the first SSB, on a first set of one or more time domain resources, and schedule reception of a downlink transmission, on a second set of one or more time domain resources that at least partially overlap with the first set of one or more time domain resources, via a beam associated with the second SSB of the second SSB group.

The reception component 1202 may receive, from the UE, an indication of support for receiving communications via multiple beams in overlapping time resources via a single component carrier or bandwidth part.

The transmission component 1204 may transmit an indication that enables scheduling, using at least partially overlapping resources, of SSBs with additional communications that are associated with an SSB group that does not include the SSBs.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a user equipment (UE), comprising: receiving an indication that associates a first synchronization signal block (SSB) to a first SSB group and a second SSB to a second SSB group, the first SSB group and the second SSB group associated with a single physical cell identifier (PCI); and receiving one or more scheduling indications that schedule reception of the first SSB, on a first set of one or more time domain resources, and schedule reception of a downlink transmission, on a second set of one or more time domain resources that at least partially overlap with the first set of one or more time domain resources, via a beam associated with the second SSB of the second SSB group.

Aspect 2: The method of Aspect 1, further comprising: transmitting an indication of support for receiving communications via multiple beams in overlapping time resources via a single component carrier or bandwidth part.

Aspect 3: The method of Aspect 2, wherein the indication of support for receiving communications via multiple beams in overlapping time resources comprises: an indication of support for receiving a first communication that includes an SSB and a second communication that includes data, control information, or a reference signal.

Aspect 4: The method of any of Aspects 1-3, wherein the first SSB group is associated with one or more of a first transmission reception point (TRP), a first panel of the UE, or a first beam group, and wherein the second SSB group is associated with one or more of a second TRP that is different from the first TRP, a second panel of the UE that is different from the first panel of the UE, or a second beam group that is different from the first beam group.

Aspect 5: The method of any of Aspects 1-4, wherein the first SSB group is associated with a first control resource set pool index, and wherein the second SSB group is associated with a second control resource set pool index.

Aspect 6: The method of any of Aspects 1-5, wherein the first SSB group and the second SSB group are associated with a group of active transmission configuration indicator (TCI) states.

Aspect 7: The method of any of Aspects 1-6, wherein a first active transmission configuration indicator (TCI) state is associated with an SSB index of the first SSB group, and wherein a second active TCI state is associated with an SSB index of the second SSB group.

Aspect 8: The method of any of Aspects 1-7, wherein receiving the indication that associates the first SSB to the first SSB group and the second SSB to the second SSB group comprises: receiving the indication that associates the first SSB to the first SSB group and the second SSB to the second SSB group via one or more of: a system information block (SIB), a unicast radio resource control (RRC) communication, a medium access control (MAC) control element (CE), or downlink control information (DCI).

Aspect 9: The method of Aspect 8, wherein a set of transmitted SSBs includes SSBs of the first SSB group and SSBs of the second SSB group.

Aspect 10: The method of any of Aspects 1-9, wherein the downlink transmission comprises one or more of: a downlink control communication, a downlink data communication, or a reference signal.

Aspect 11: The method of any of Aspects 1-10, wherein the UE supports reception of the first SSB and the downlink transmission on overlapping resources based at least in part on one or more of: the second SSB being associated with an active transmission configuration indicator (TCI) state, the first SSB being associated with a first active TCI state and the second SSB being associated with a second active TCI state, or the first SSB not being associated with an active TCI state.

Aspect 12: The method of any of Aspects 1-11, wherein the UE supports reception of the first SSB and the downlink transmission on overlapping resources based at least in part on: the first SSB not being configured for reference signal received power (RSRP) measurement.

Aspect 13: The method of any of Aspects 1-12, wherein the first SSB is configured for reference signal received power (RSRP) measurement.

Aspect 14: The method of any of Aspects 1-13, further comprising: receiving an indication that enables scheduling, using at least partially overlapping resources, of SSBs with additional communications that are associated with an SSB group that does not include the SSBs.

Aspect 15: A method of wireless communication performed by a network node, comprising: transmitting an indication that associates a first synchronization signal block (SSB) to a first SSB group and a second SSB to a second SSB group, the first SSB group and the second SSB group associated with a single physical cell identifier (PCI); and transmitting, to a user equipment (UE), one or more scheduling indications that schedule reception of the first SSB, on a first set of one or more time domain resources, and schedule reception of a downlink transmission, on a second set of one or more time domain resources that at least partially overlap with the first set of one or more time domain resources, via a beam associated with the second SSB of the second SSB group.

Aspect 16: The method of Aspect 15, further comprising: receiving, from the UE, an indication of support for receiving communications via multiple beams in overlapping time resources via a single component carrier or bandwidth part.

Aspect 17: The method of Aspect 16, wherein the indication of support for receiving communications via multiple beams in overlapping time resources comprises: an indication of support for receiving a first communication that includes an SSB and a second communication that includes data, control information, or a reference signal.

Aspect 18: The method of any of Aspects 15-17, wherein the first SSB group is associated with one or more of a first transmission reception point (TRP) associated with the network node, a first panel of the UE, or a first beam group, and wherein the second SSB group is associated with one or more of a second TRP that is different from the first TRP and is associated with the network node, a second panel of the UE that is different from the first panel of the UE, or a second beam group that is different from the first beam group.

Aspect 19: The method of any of Aspects 15-18, wherein the first SSB group is associated with a first control resource set pool index, and wherein the second SSB group is associated with a second control resource set pool index.

Aspect 20: The method of any of Aspects 15-19, wherein the first SSB group and the second SSB group are associated with a group of active transmission configuration indicator (TCI) states.

Aspect 21: The method of any of Aspects 15-20, wherein a first active transmission configuration indicator (TCI) state is associated with an SSB index of the first SSB group, and wherein a second active TCI state is associated with an SSB index of the second SSB group.

Aspect 22: The method of any of Aspects 15-21, wherein transmitting the indication that associates the first SSB to the first SSB group and the second SSB to the second SSB group comprises: transmitting the indication that associates the first SSB to the first SSB group and the second SSB to the second SSB group via one or more of: a system information block (SIB), a unicast radio resource control (RRC) communication, a medium access control (MAC) control element (CE), or downlink control information (DCI).

Aspect 23: The method of Aspect 22, wherein a set of transmitted SSBs includes SSBs of the first SSB group and SSBs of the second SSB group.

Aspect 24: The method of any of Aspects 15-23, wherein the downlink transmission comprises one or more of: a downlink control communication, a downlink data communication, or a reference signal.

Aspect 25: The method of any of Aspects 15-24, wherein the UE supports reception of the first SSB and the downlink transmission on overlapping resources based at least in part on one or more of: the second SSB being associated with an active transmission configuration indicator (TCI) state, the first SSB being associated with a first active TCI state and the second SSB being associated with a second active TCI state, or the first SSB not being associated with an active TCI state.

Aspect 26: The method of any of Aspects 15-25, wherein the UE supports reception of the first SSB and the downlink transmission on overlapping resources based at least in part on: the first SSB not being configured for reference signal received power (RSRP) measurement.

Aspect 27: The method of any of Aspects 15-26, wherein the first SSB is configured for reference signal received power (RSRP) measurement.

Aspect 28: The method of any of Aspects 15-27, further comprising: transmitting an indication that enables scheduling, using at least partially overlapping resources, of SSBs with additional communications that are associated with an SSB group that does not include the SSBs.

Aspect 29: An apparatus for wireless communication at a device, comprising a processor; memory coupled with the processor; and instructions stored in the memory and executable by the processor to cause the apparatus to perform the method of one or more of Aspects 1-28.

Aspect 30: A device for wireless communication, comprising a memory and one or more processors coupled to the memory, the one or more processors configured to perform the method of one or more of Aspects 1-28.

Aspect 31: An apparatus for wireless communication, comprising at least one means for performing the method of one or more of Aspects 1-28.

Aspect 32: A non-transitory computer-readable medium storing code for wireless communication, the code comprising instructions executable by a processor to perform the method of one or more of Aspects 1-28.

Aspect 33: A non-transitory computer-readable medium storing a set of instructions for wireless communication, the set of instructions comprising one or more instructions that, when executed by one or more processors of a device, cause the device to perform the method of one or more of Aspects 1-28.

The foregoing disclosure provides illustration and description but is not intended to be exhaustive or to limit the aspects to the precise forms disclosed. Modifications and variations may be made in light of the above disclosure or may be acquired from practice of the aspects.

Further disclosure is included in the appendix. The appendix is provided as an example only and is to be considered part of the specification. A definition, illustration, or other description in the appendix does not supersede or override similar information included in the detailed description or figures. Furthermore, a definition, illustration, or other description in the detailed description or figures does not supersede or override similar information included in the appendix. Furthermore, the appendix is not intended to limit the disclosure of possible aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
one or more memories; and
one or more processors, coupled to the one or more memories, configured to:
receive an indication that associates a first synchronization signal block (SSB) to a first SSB group and a second SSB to a second SSB group, the first SSB group and the second SSB group associated with a single physical cell identifier (PCI); and
receive one or more scheduling indications that schedule reception of the first SSB, on a first set of one or more time domain resources, and schedule reception of a downlink transmission, on a second set of one or more time domain resources that at least partially overlap with the first set of one or more time domain resources, via a beam associated with the second SSB of the second SSB group.

2. The UE of claim 1, wherein the one or more processors are further configured to:
transmit an indication of support for receiving communications via multiple beams in overlapping time resources via a single component carrier or bandwidth part.

3. The UE of claim 2, wherein the indication of support for receiving communications via multiple beams in overlapping time resources comprises:
an indication of support for receiving a first communication that includes an SSB and a second communication that includes data, control information, or a reference signal.

4. The UE of claim 1, wherein the first SSB group is associated with one or more of a first transmission reception point (TRP), a first panel of the UE, or a first beam group, and
wherein the second SSB group is associated with one or more of a second TRP that is different from the first TRP, a second panel of the UE that is different from the first panel of the UE, or a second beam group that is different from the first beam group.

5. The UE of claim 1, wherein the first SSB group is associated with a first control resource set pool index, and
wherein the second SSB group is associated with a second control resource set pool index.

6. The UE of claim 1, wherein the first SSB group and the second SSB group are associated with a group of active transmission configuration indicator (TCI) states.

7. The UE of claim 1, wherein a first active transmission configuration indicator (TCI) state is associated with an SSB index of the first SSB group, and
wherein a second active TCI state is associated with an SSB index of the second SSB group.

8. The UE of claim 1, wherein the one or more processors, to receive the indication that associates the first SSB to the first SSB group and the second SSB to the second SSB group, are configured to:
receive the indication that associates the first SSB to the first SSB group and the second SSB to the second SSB group via one or more of:
a system information block (SIB),
a unicast radio resource control (RRC) communication,
a medium access control (MAC) control element (CE), or
downlink control information (DCI).

9. The UE of claim 8, wherein a set of transmitted SSBs includes SSBs of the first SSB group and SSBs of the second SSB group.

10. The UE of claim 1, wherein the downlink transmission comprises one or more of:
a downlink control communication,
a downlink data communication, or
a reference signal.

11. The UE of claim 1, wherein the UE supports reception of the first SSB and the downlink transmission on overlapping resources based at least in part on one or more of:
the second SSB being associated with an active transmission configuration indicator (TCI) state,
the first SSB being associated with a first active TCI state and the second SSB being associated with a second active TCI state, or
the first SSB not being associated with an active TCI state.

12. The UE of claim 1, wherein the UE supports reception of the first SSB and the downlink transmission on overlapping resources based at least in part on:
the first SSB not being configured for reference signal received power (RSRP) measurement.

13. The UE of claim 1, wherein the first SSB is configured for reference signal received power (RSRP) measurement.

14. The UE of claim 1, wherein the one or more processors are further configured to:
receive an indication that enables scheduling, using at least partially overlapping resources, of SSBs with additional communications that are associated with an SSB group that does not include the SSBs.

15. A network node for wireless communication, comprising:
one or more memories; and
one or more processors, coupled to the one or more memories, configured to:
transmit an indication that associates a first synchronization signal block (SSB) to a first SSB group and a second SSB to a second SSB group, the first SSB group and the second SSB group associated with a single physical cell identifier (PCI); and
transmit, to a user equipment (UE), one or more scheduling indications that schedule reception of the first SSB, on a first set of one or more time domain resources, and schedule reception of a downlink transmission, on a second set of one or more time domain resources that at least partially overlap with the first set of one or more time domain resources, via a beam associated with the second SSB of the second SSB group.

16. The network node of claim 15, wherein the one or more processors are further configured to:
receive, from the UE, an indication of support for receiving communications via multiple beams in overlapping time resources via a single component carrier or bandwidth part.

17. The network node of claim 16, wherein the indication of support for receiving communications via multiple beams in overlapping time resources comprises:
an indication of support for receiving a first communication that includes an SSB and a second communication that includes data, control information, or a reference signal.

18. The network node of claim 15, wherein the first SSB group is associated with one or more of a first transmission reception point (TRP) associated with the network node, a first panel of the UE, or a first beam group, and
wherein the second SSB group is associated with one or more of a second TRP that is different from the first TRP and is associated with the network node, a second panel of the UE that is different from the first panel of the UE, or a second beam group that is different from the first beam group.

19. The network node of claim 15, wherein the first SSB group is associated with a first control resource set pool index, and
wherein the second SSB group is associated with a second control resource set pool index.

20. The network node of claim 15, wherein the first SSB group and the second SSB group are associated with a group of active transmission configuration indicator (TCI) states.

21. The network node of claim 15, wherein a first active transmission configuration indicator (TCI) state is associated with an SSB index of the first SSB group, and
wherein a second active TCI state is associated with an SSB index of the second SSB group.

22. The network node of claim 15, wherein the one or more processors, to transmit the indication that associates the first SSB to the first SSB group and the second SSB to the second SSB group, are configured to:
transmit the indication that associates the first SSB to the first SSB group and the second SSB to the second SSB group via one or more of:
a system information block (SIB),
a unicast radio resource control (RRC) communication,
a medium access control (MAC) control element (CE), or
downlink control information (DCI).

23. The network node of claim 22, wherein a set of transmitted SSBs includes SSBs of the first SSB group and SSBs of the second SSB group.

24. The network node of claim 15, wherein the downlink transmission comprises one or more of:
a downlink control communication,
a downlink data communication, or
a reference signal.

25. The network node of claim 15, wherein the UE supports reception of the first SSB and the downlink transmission on overlapping resources based at least in part on one or more of:
the second SSB being associated with an active transmission configuration indicator (TCI) state,
the first SSB being associated with a first active TCI state and the second SSB being associated with a second active TCI state, or
the first SSB not being associated with an active TCI state.

26. The network node of claim 15, wherein the UE supports reception of the first SSB and the downlink transmission on overlapping resources based at least in part on:
the first SSB not being configured for reference signal received power (RSRP) measurement.

27. The network node of claim 15, wherein the first SSB is configured for reference signal received power (RSRP) measurement.

28. The network node of claim 15, wherein the one or more processors are further configured to:
transmit an indication that enables scheduling, using at least partially overlapping resources, of SSBs with additional communications that are associated with an SSB group that does not include the SSBs.

29. A method of wireless communication performed by a user equipment (UE), comprising:
receiving an indication that associates a first synchronization signal block (SSB) to a first SSB group and a second SSB to a second SSB group, the first SSB group and the second SSB group associated with a single physical cell identifier (PCI); and
receiving one or more scheduling indications that schedule reception of the first SSB, on a first set of one or more time domain resources, and schedule reception of a downlink transmission, on a second set of one or more time domain resources that at least partially overlap with the first set of one or more time domain resources, via a beam associated with the second SSB of the second SSB group.

30. A method of wireless communication performed by a network node, comprising:
transmitting an indication that associates a first synchronization signal block (SSB) to a first SSB group and a second SSB to a second SSB group, the first SSB group and the second SSB group associated with a single physical cell identifier (PCI); and
transmitting, to a user equipment (UE), one or more scheduling indications that schedule reception of the first SSB, on a first set of one or more time domain resources, and schedule reception of a downlink transmission, on a second set of one or more time domain resources that at least partially overlap with the first set of one or more time domain resources, via a beam associated with the second SSB of the second SSB group.
